(19) United States
(12) Patent Application Publication
(10) Pub. No.: US 2008/0105216 A1
(43) Pub. Date: May 8, 2008

(54) Canine control harness

(76) Inventor: Joseph S. Sporn, New York, NY (US)

Correspondence Address: HANES & SCHUTZ, LLC, 102 SOUTH TEJON ST., SUITE 800, COLORADO SPRINGS, CO, 80903, US

(21) Appl. No.: 11/593,260

(22) Filed: Nov. 6, 2006

(51) Int. Cl. A01K 27/00

(52) U.S. Cl. 119/863

(57) ABSTRACT

A canine control harness having an upper chest strap and a brisket strap, each having first and second ends, where the first ends are interconnected and the second ends are interconnected at respectively laterally spaced apart points over the withers of the dog and including an endless loop strap that slidingly interconnects the spaced apart points of attachment so that tension force applied to the top side of the endless loop will draw the points of attachment together and apply inwardly directed pressure to the body of the dog.

### FIELD OF THE INVENTION

The present invention relates to a harness for small animals that may be led or controlled by a leash.

The primary object of the invention is to provide a harness, primarily intended for dogs, that is simple to put on and humanely applies control pressure to the dog's body instead of just to the throat or neck as is done with the traditional dog collar.

### SUMMARY OF THE INVENTION

The control harness of the present invention comprises a chest strap and a brisket strap, the left and right ends of which are respectively interconnected at laterally spaced apart positions over the withers of the dog. These spaced apart points of strap interconnection are connected together by an endless loop strap or similar device that, when tensioned by pulling on a leash connected to the top side of the endless loop, will draw the interconnected ends of the chest and brisket straps together, applying inwardly directed pressure to the chest and shoulder area of the dog instead of isolating control pressure to the throat of a dog wearing a traditional collar.

### DESCRIPTION OF THE DRAWINGS

FIG. 1 is a prospective view of the control harness of the present invention being worn by a dog. The lead leash is fragmentarily shown in phantom lines.

FIG. 2 is a prospective view of the control harness.

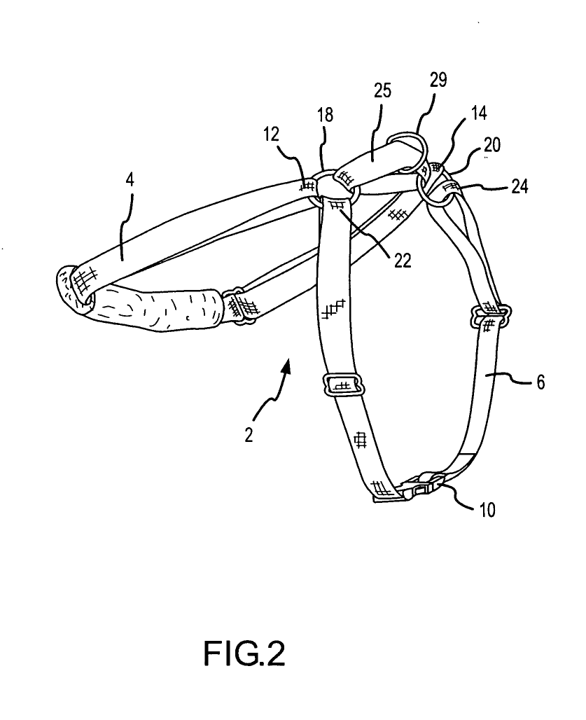

### DETAILED DESCRIPTION OF PREFERRED EMBODIMENT

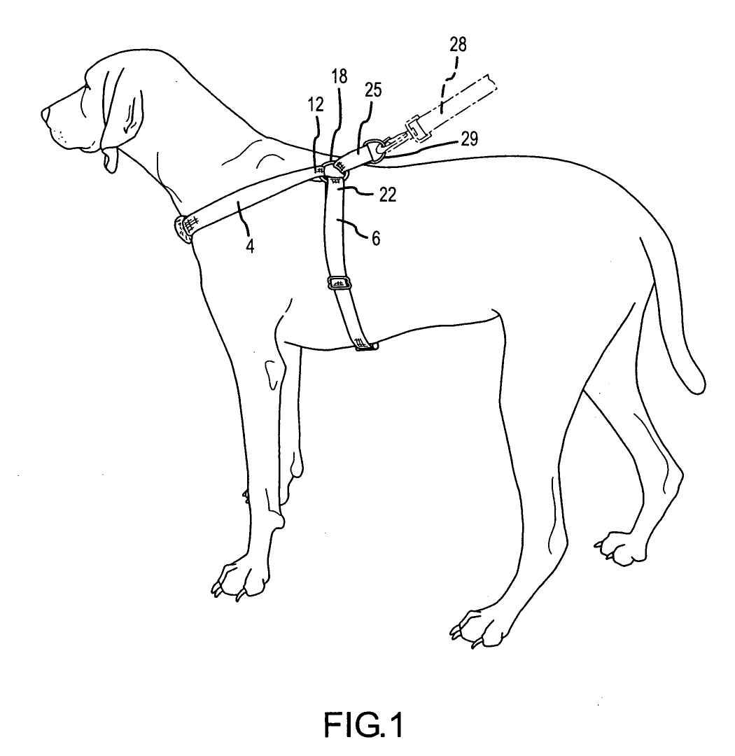

As seen in FIG. 1, the harness 2 of the present invention includes a chest strap 4 and a brisket strap 6 that are interconnected over the withers in a novel manner to be explained. In this specification the brisket of a dog shall be considered that portion of the chest behind the front legs. With respect to the chest strap 4, the strap engages the upper chest, sometimes referred to as the fore-chest and traverses an area over each of the shoulders of the dog. Preferably, the chest strap is placed over the dog's head while the brisket strap is in two parts that are connected by a buckle 10 in order to secure the harness to the dog's body.

The ends 12 and 14 of the chest strap 4 are attached to connector rings 18 and 20 as are the ends 22 and 24 of the brisket strap 6. When the length of the brisket strap is properly adjusted the attachment rings 18 and 20 are positioned over the withers of the dog at respectively left and right locations laterally of the dog's spine.

In the preferred embodiment an endless loop strap 25 slidingly runs through each of the attachment rings 18 and 20. A lead leash 28 is attached to the top side of the endless loop strap 25 with a ring 29 or similar means. When the top side of the endless loop is pulled or drawn by the leash the bottom side of the loop shortens and pulls the attachment rings 18 and 20 together. When the attachment rings are drawn together the ends of both the chest strap and the brisket strap are also drawn together, applying inward pressure against the chest and shoulder areas of the dog. Such pressure enables the handler to exert control over the dog without the strangulation incident to a traditional neck collar. If the leash is pulled to one side or the other of the dog, greater pressure will be brought to bear on the opposite side, indicating that the dog should turn.

What is claimed is:

1. A canine control harness, comprising,
an upper chest strap having first and second ends,
a brisket strap having first and second ends,
first attachment means for interconnecting the first ends of the upper chest strap and the brisket strap,
second attachment means interconnecting the second ends of the upper chest strap and the brisket strap,
means interconnecting the first and second attachment means for selectively drawing the attachment means together.

2. The harness of claim 1 where the first and second attachment means are rings.

3. The harness of claims 2 where the means interconnecting the first and second attachment means is an endless loop of materials.

4. The harness of claim 3 where the endless loop passes through and slidingly engages each of the rings.

5. The harness of claim 4 where the endless loop includes means for attaching the loop to a lead leash.

6. A canine control harness, comprising,
an upper chest strap having first and second ends,
a brisket strap having first and second ends,
first ring means positioned over the withers of the canine and laterally left of the canine spine for interconnecting the first ends of the upper chest strap and the brisket strap,
second ring means positioned over the withers of the canine and laterally right of the canine spine for interconnecting the second ends of the upper chest strap and the brisket strap,
endless loop means interconnecting the first and second ring means for selectively contracting the distance between the first and second ring means.
